(19) United States
(12) Patent Application Publication
(10) Pub. No.: US 2001/0008535 A1
(43) Pub. Date: Jul. 19, 2001

(54) Interconnection of audio/video devices

(75) Inventor: Peter J. Lanigan, Croydon (GB)

Correspondence Address: Michael E. Marion, Corporate Patent Counsel, U.S. Philips Corporation, 580 White Plains Road, Tarrytown, NY, 10591, US

(73) Assignee: U.S. PHILIPS CORPORATION

(21) Appl. No.: 09/759,182

(22) Filed: Jan. 12, 2001

(30) Foreign Application Priority Data
Jan. 14, 2000 (GB) 0000873.0

(51) Int. Cl. H04J 1/00; H04J 3/06; H04J 3/04

(52) U.S. Cl. 370/487; 370/503; 370/535

(57) ABSTRACT

A data processing system comprises a cluster of devices (16) interconnected for the communication of data in streams, particularly digital audio and/or video data. One of the devices (10) is a source device for at least two data streams to be sent to one or more other devices (12, 14) as destination devices of the cluster. To enable synchronisation of the stream presentations by the destination devices, the source device (10) includes buffers (20, 22) arranged to apply a respective delay to at least one of the data streams, followed by a multiplexer (32) arranged to combine the streams into a single data stream for transmission via a first data channel (18) linking said source (10) and destination (12, 14) devices. The source device may include data processing means (34, 36) interposed in the signal path between the buffers and multiplexer.

The present invention relates to systems composed of a plurality of devices clustered for the exchange of data, preferably audio and/or video data and control messages, via wired or wireless link and, in particular although not essentially, to such systems where different data components from a source device are to be routed to respective and separate other devices of the system. The invention further relates to source devices for use in such systems.

Networking or interconnection of devices has long been known and used, starting from basic systems where different system functions have been provided by separate units, for example hi-fi or so-called home cinema systems. A development has been the so-called home bus systems where a greater variety of products have been linked with a view to providing enhanced overall functionality in for example domestic audio/video apparatus coupled with a home security system and the use of telephone. An example of such a home bus system is the domestic digital bus (D2B), the communications protocols for which have been issued as standard IEC 1030 by the International Electrotechnical Commission in Geneva, Switzerland. The D2B system provides a single wire control bus to which all devices are interfaced with messages carried between the various devices of the system in a standardised form of data packet.

A particular problem that can occur with distributed systems such as hi-fi and home cinema is loss of synchronisation between different components required to be presented to a user simultaneously. This is particularly noticeable where the loss of synchronisation is between sequences of video images and an accompanying soundtrack, or between different audio components intended to be presented by different devices, particularly in a surround-sound or home-cinema installation. This loss of synchronisation may occur due differences in the effective lengths of the transmission paths for the differing components, or it may be due to different latencies in decoders for the different components.

One way to approach the synchronisation problem, where all the components are decoded within a single device, is described in U.S. Pat. No. 5,430,485 (Lankford et al) which describes a receiver for decoding associated compressed video and audio information components transmitted in mutually exclusive frames of data, each with a respective presentation time stamp. A coarse synchronisation is applied by selectively dropping frames of one or other of the components and then fine tuning by adjusting the audio stream clock frequency.

Another approach, this time closer to the source for different components being sent out, is described in U.S. Pat. No. 5,594,660 (Sung et al) which provides an audio/video decoder/decompressor for receiving and separating the components of an encoded and compressed data stream. Within the decoder/decompressor, Sung has means for breaking up a compound AV stream and then applying an appropriate temporal offset to each stream to achieve synchronisation of the outputs during playback. The differential buffering by FIFO units follows the system decoder but precedes the decoding of the audio or of the video.

Although handling the component delays with the components still encoded generally involves less processing, handling of synchronisation at source can create its own problems when it comes to avoiding conflict for transport resources to get the offset streams to their destination without introducing further delays (and hence un-synchronising the streams) and/or requiring separate and parallel signal paths for the separated components.

It is accordingly an object of the present invention to provide a networked system of devices including means for synchronising components from source whilst avoiding the creating of delays through competition between source and destination.

In accordance with the present invention there is provided a data processing system comprising a cluster of devices interconnected for the communication of data in streams, wherein one of said devices is a source device for at least two data streams to be sent to one or more other devices as destination devices of said cluster, said source device including: buffering means arranged to apply a respective delay to at least one of said at least two data streams; and multiplexing means coupled with said buffering means and arranged to combine said at least two streams into a single data stream for transmission; the system further comprising a first data channel linking said source and destination devices and carrying said data stream for transmission from the source device to the or each destination device. By applying the respective delays at source, the amount of signal buffering received by the destination devices is kept to a lower level, whilst the multiplexing of the signal streams with latency offsets applied reduces congestion problems arising from separate streams competing for transmission pathways.

The source device may further comprise an input to receive the said at least two data streams from a remote source (such as a further connected device or perhaps an internal utility such as an optical disc reader). With such an arrangement, where the at least two data streams are multiplexed together when received by said source device, the source device suitably further comprises demultiplexing means coupling the input and the buffering means and arranged to separate said streams prior to buffering.

In a preferred embodiment, the aforementioned at least two data streams comprise digital video data and audio data (which may be digital audio data) respectively, wherein the digital video data may have a different destination device to the audio data.

To allow further treatments to the signals to be sent out, the source device may further comprise data processing means interposed in the signal path between the buffering and multiplexing means, or prior to the buffering means.

The present invention also provides a data processing apparatus comprising the technical features of a source device in a system as recited hereinabove and as claimed in the claims attached hereto, to which the readers attention is now directed.

Further features and advantages of the present invention will become apparent from reading of the description of preferred embodiments of the invention, given by way of example only and with reference to the accompanying drawings, in which:

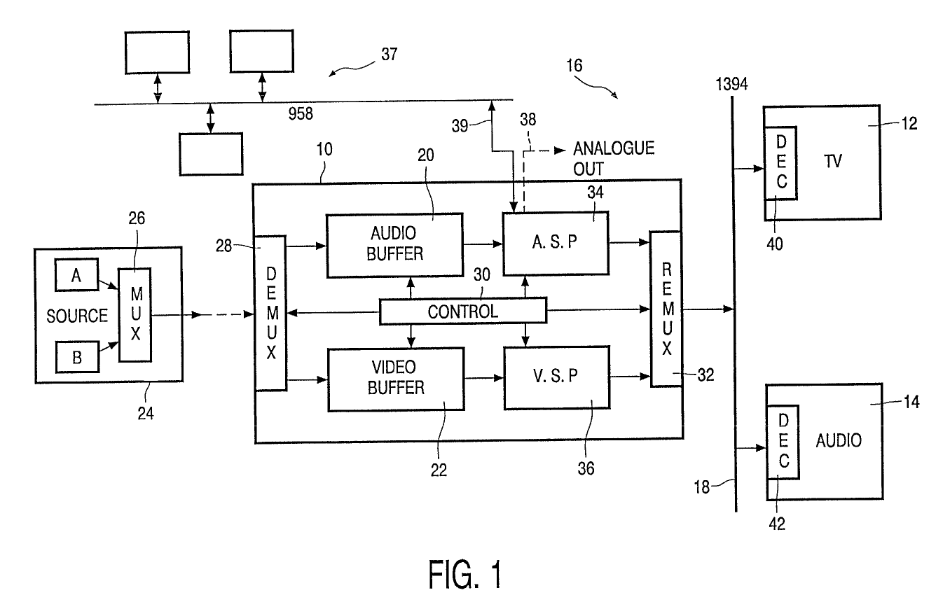

FIG. 1 represents an arrangement of three interconnected devices forming an audio/video cluster;

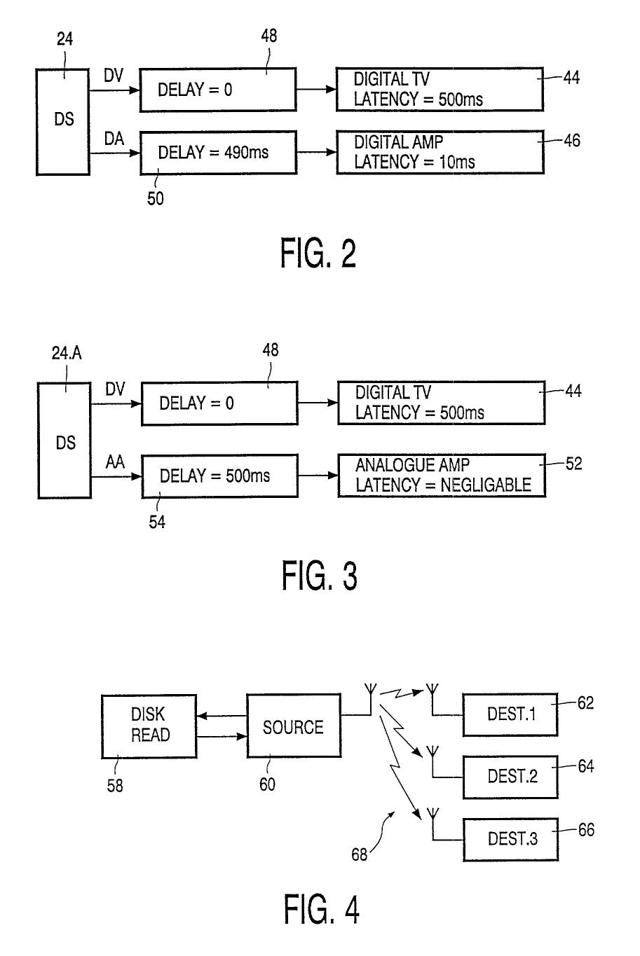

FIG. 2 represents a first application of differential delays applied to separate components from a first source;

FIG. 3 represents an alternative application of delays to that of FIG. 2; and

FIG. 4 represents an alternative (wireless) interconnect mechanism suitable to embody the present invention.

A first arrangement of interconnected devices is shown in FIG. 1, with three devices 10, 12, 14 forming a cluster 16 based around a respective bus 18 supporting communication in accordance with IEEE Standard 1394 connect and communications protocols. In the following example, reference is made to IEEE 1394, and the disclosure of the specification of this protocol is incorporated herein by reference. As will be recognised by the skilled reader, however, conformance with such protocol is not essential to the operation of the present invention.

The devices in the cluster 16 comprise a source device 10 coupled via bus 18 to a television 12 for showing the image component of a combined AV stream from the source, and an audio processor and playback system 14 for reproducing the audio component of the AV stream. The source device 10 comprises an audio stream buffer 20 and a video stream buffer 22 for receiving separate input components from a remote signal source 24. As shown, the separate source components A and B are combined in a multiplexer 26 with the source device 10 having a corresponding demultiplexer 28 to separate the components prior to loading them into the respective buffers 20, 22.

Under the direction of a controlling processor 30, the buffers are used to apply a respective delay to at least one of the two data streams to combat the differing processing latencies in the video 12 and audio 14 destination devices, as will be described in further detail hereinafter with respect to FIGS. 2 and 3. Also under the direction of the processor 30, a multiplexer stage 32 remultiplexes the temporally offset audio and video from the respective buffers to combine the two streams into a single data stream for transmission via the 1394 bus 18.

Whilst the signals in the respective buffers 20, 22 may simply be read out and recombined, the source device optionally further comprises data processing means interposed in the signal path between the buffers 20, 22 and the multiplexer 32. As shown, this further data processing means may take the form of an audio signal processor ASP 34 on the output to the audio signal buffer and a video signal processor VSP 36 on the output to the video signal buffer. The ASP 34 may be used for tasks such as conversion from AC3 or MPEG Audio to LPCM, such that only the source device would then require a decoder for these formats. The video processing by VSP 36 could include overlaying graphics and/or various forms of re-encoding, for example to identify MPEG l-fields. Whilst the output from the audio buffer 20 is typically passed to the multiplexer 32 in digitised form, an analogue audio signal may be required for communication with other (non 1394-compliant) devices and, to this end the ASP 34 may include a D/A converter (not shown) such as to provide an analogue audio output 38. Alternately, the ASP 34 might act as a gateway to a second cluster 37 by providing a link 39 supporting conversion to (and optionally from) a different interconnect protocol such as IEC958: this arrangement has particular value when, for example, it is desired to watch a digital video on television 12 conforming to IEEE1394 whilst listening to the audio on a slightly older system conforming to IEC958. As will be recognised, in some circumstances it may be desirable to provide the ASP 34 and/or VSP 36 before the respective buffer 20,22.

The first and second data streams (audio and video) may be encoded according to a first communications protocol such as MPEG1 or 2, and the destination devices 12, 14 are each provided with a respective decoder 40, 42 operating according to the said protocol.

Turning now to FIG. 2, the differential delays applied are illustrated with a data source DS 24 outputting digital video DV and digital audio DA to respectively a digital television 44 and a digital amplifier 46 via respective buffers 48, 50. The digital source 24 may comprise, for example, a DVD player and the digital TV 44 may be provided with an MPEG2 decoder to handle the coded video from the source, and the digital amplifier may be provided with an AC3 decoder for the coded audio. Typically, the latency of the AC3 decoder will be of the order of 10 ms as against 500 ms for the MPEG2 decoder. Consequently, to maintain synchronism between the audio and video playback, the audio signal is delayed in the buffer 50 by (500−10)=490 ms, with the digital video being pipelined directly through the video buffer 48 with no delay.

FIG. 3 shows an alternative scenario to that of FIG. 2: in this case, the source is modified 24.A and outputs an analogue audio signal AA via analogue delay line 54 to analogue amplifier 52. In the absence of any specific coding, the latency of the analogue amplifier is assumed negligible and consequently the delay introduced by buffering (in delay line 54) must be (500−0)=500 ms. Other variations are, of course, possible with the output from source 24.A instead comprising a digital audio stream but, unlike the FIG. 2 embodiment, the video and audio streams conform to separate protocols (such as IEEE 1394 for the video and IEC958 for the audio) with respective delay settings being as for the digital plus analogue case of FIG. 3, or varied in dependence on the actual settings, as will be recognised by the skilled reader.

From reading the present disclosure, other modifications and variations will be apparent to persons skilled in the art, including equivalents and features which are already known in the field of bus-connected and cordless communication systems and components and which may be used instead of or in addition to features already disclosed herein. For example, as shown by FIG. 4, the source 58 may comprise an optical or magnetic disk reader and, instead of a digital data bus, the data channel from source 60 to destination devices 62, 64, 66 may be a wireless communications link 68 for which each of the destination devices is provided with at least a receiver and the source device is provided with at least a transmitter. The system may comprise many more devices than illustrated herein including, for example, two or more source devices, and some devices of the system may have the technical features of both source and destination (for example a video cassette record and playback deck) with the appropriate source/destination behaviour being selected in dependence on the context.

In the foregoing we have described a data processing system comprising a cluster of devices interconnected for the communication of data in streams, particularly digital audio and/or video data. One of the devices is a source device for at least two data streams to be sent to one or more other devices as destination devices of the cluster. To enable synchronisation of the stream presentations by the destination devices, the source device includes buffers to apply a respective delay to at least one of the data streams, followed by a multiplexer arranged to combine the streams into a single data stream for transmission via a data channel linking the source and destination devices.

Claims:

1. A data processing system comprising a cluster of devices interconnected for the communication of data in streams, wherein one of said devices is a source device for at least two data streams to be sent to one or more other devices as destination devices of said cluster, said source device including:
buffering means arranged to apply a respective delay to at least one of said at least two data streams; and
multiplexing means coupled with said buffering means and arranged to combine said at least two streams into a single data stream for transmission;
the system further comprising a first data channel linking said source and destination devices and carrying said data stream for transmission from the source device to the or each destination device.

2. A system as claimed in claim 1, wherein said source device further comprises an input to receive said at least two data streams from a remote source.

3. A system as claimed in claim 2, wherein said at least two data streams are multiplexed together when received by said source device, said source device further comprising demultiplexing means coupling said input and said buffering means and arranged to separate said streams prior to buffering.

4. A system as claimed in claim 1, wherein said at least two data streams comprise digital video data and audio data respectively, wherein the digital video data has a different destination device to the audio data.

5. A system as claimed in claim 4, wherein said audio data is digital audio data.

6. A system as claimed in claim 1, wherein said source device further comprises data processing means interposed in the signal path between said buffering means and said multiplexing means.

7. A system as claimed in claim 1, wherein the first and second data streams are encoded according to a first communications protocol, and the or each destination device comprises a respective decoder operating according to said protocol.

8. A system as claimed in claim 1, wherein said first data channel is a digital data communication bus to which the devices are respectively interfaced, with said multiplexed data streams being carried thereupon as discrete data packets.

9. A system as claimed in claim 1, wherein said first data channel is a wireless communications link for which each of the destination devices is provided with at least a receiver and said source device is provided with at least a transmitter.

10. A system as claimed in claim 1, comprising two or more source devices.

11. A system as claimed in claim 10, wherein at least one of said two or more source devices further comprises the technical features of a destination device of the system.

12. Data processing apparatus comprising the technical features of a source device in a system as claimed in claim 1.

13. Data processing apparatus as claimed in claim 12, further comprising the technical features of a destination device in a system as claimed in claim 1.
